(19) United States
(12) Patent Application Publication
(10) Pub. No.: US 2005/0211778 A1
(43) Pub. Date: Sep. 29, 2005

(54) Voting system and method for secure voting with increased voter confidence

(76) Inventor: David L. Biddulph, New Smyrna Beach, FL (US)

Correspondence Address: Alan M. Weisberg;Christopher & Weisberg, P.A., Suite 2040, 200 East Las Olas Boulevard, Fort Lauderdale, FL, 33301, US

(21) Appl. No.: 11/121,757

(22) Filed: May 4, 2005

Related U.S. Application Data
(63) Continuation-in-part of application No. 09/852,877, filed on May 10, 2001.

(51) Int. Cl. G06F 17/60; G07C 13/00

(52) U.S. Cl. 235/386; 705/12

(57) ABSTRACT

An information gathering system and method that utilizes a computer to authenticate, poll and store user responses to a customized questionnaire. The questionnaire can be a ballot. The computer utilizes various databases to authenticate and generate the customized questionnaire. The computer records user responses securely and anonymously. User and/or system errors are eliminated before finalizing the response database. An identification number is assigned to each user which allows the user to verify the integrity of the user's response by accessing a response database. The user is provided access to a tabulation database to allow the user to verify the user's voting choices and the voting choices of other voters.

### CROSS-REFERENCE TO RELATED APPLICATION

This application is a continuation-in-part of pending U.S. Utility patent application Ser. No. 09/852,877, filed May 10, 2001, entitled VOTING SYSTEM AND METHOD FOR SECURE VOTING WITH INCREASED VOTER CONFIDENCE, the entirety of which is incorporated herein by reference.

### STATEMENT REGARDING FEDERALLY SPONSORED RESEARCH OR DEVELOPMENT

n/a

### FIELD OF THE INVENTION

The present invention relates to an information gathering system and method, and in particular, to a voting system and method that greatly reduces errors common to voting systems, maintains voter anonymity, and increases election transparency and thus, voter confidence.

### BACKGROUND OF THE INVENTION

As was graphically illustrated by the 2000 Presidential Election in the United States, a key element in a representative form of government is the ability of the electorate to participate in a meaningful way in the electoral process and do so in a way that engenders a high degree of confidence in the results.

Various voting systems have been known for thousands of years but it was not until the second half of the 19th Century that voting machines were introduced. One of the factors that led to a push for mechanizing the vote was the relatively new concept of a general “secret” ballot. The introduction of the machine to the process of voting held the promise of simplifying a secret ballot process while providing faster, more reliable results free from the error and corruption often associated with hand counting of votes. Although the widespread use of voting machines is a testament to the fulfillment of at least some of their potential, in actual practice, the machines have not always lived up to their promise.

One limitation of prior voting systems that hampers voter confidence is related to the “secret ballot” concept that has come to be regarded as a sacred right by the populace. The fact that no one has a “right to know” how a person votes, while encouraging “voting your conscience,” undermines the ability to be sure that every vote has been counted and counted the way the voter intended. Additionally, voter confidence is influenced by the knowledge that we all make mistakes and no equipment is perfect but, traditionally, once the vote is cast, there is little that the voter can do to recheck the accuracy of their vote, correct simple mistakes or even know how the election equipment actually recorded their vote.

It is therefore desirable to have a system and method which allows a voter to cast a vote in a simple manner while preserving the secrecy of the vote as well as allowing the voter to confirm that the vote was counted in the official election tabulation in accordance with the voter's intent.

### SUMMARY OF THE INVENTION

The present invention advantageously provides an information gathering system utilizing a computer and databases accessible by the computer. Input devices such as a keyboard, scanner, microphone or touch screen are coupled to the computer as well as an output device such as a printer. A software program is utilized by the computer to perform the present invention.

According to one aspect, the present invention provides an information gathering system that uses at least one computer and an identification database accessible by the computer. The identification database includes user identification information. At least one output device is coupled to the computer. An executable software component is executable by the computer and is arranged to validate the user and cause the computer to provide output on the output device corresponding to a customized ballot prepared based upon a validated user response to a specified request for information.

According to another aspect, the present invention provides a method of gathering information about a user using a computer in which the user's eligibility to participate by consulting a first database is verified. A unique identifier is assigned to a customized ballot. A questionnaire is customized by consulting a second database. The eligible user is required to provide to the computer a response to the questionnaire. A first tangible record of the response is produced. A second tangible record of the response is produced. The second tangible record is collected and stored.

According to yet another aspect, the present invention provides a method of voting using a computer in which the eligibility of a potential voter is checked by accessing a voter eligibility database. The potential voter who is deemed to be a non-eligible voter is rejected. An address of an eligible voter is received. A ballot based on a selected criteria is customized by accessing a ballot form database. The ballot is displayed to the eligible voter on a screen, on paper, via audio speaker or other suitable device. The voter indicates their ballot selections. The ballot is received from the eligible voter and checked for errors by comparing the ballot to a selected standard. An official ballot is printed and collected. A receipt is also printed.

According to a further aspect, the present invention provides an information gathering system, which utilizes a means for identifying a user. Once the user is identified, the system provides a means for verifying the user's status to participate in the information gathering system and a means for assigning a unique identifier to a customized ballot. The system further uses a means for displaying a customized questionnaire, the customized questionnaire prompting the user to enter at least a first response to at least one question on the customized questionnaire. A means for storing the first response, and a means for producing a tangible record of the first response and the unique identifier, is also provided for by the present invention. The system further provides a means for allowing the user to compare the tangible record with the first response, as well as a means for correcting a discrepancy between the tangible record and the first response.

According to yet a further aspect, the present invention provides a method of gathering information in which a user's status to participate in the information gathering system is verified. A unique identifier is assigned to a customized ballot. A customized questionnaire is displayed to the user. The user is prompted to enter at least a first response to at least one question on the customized questionnaire. At least the first response is stored. A tangible record of at least the first response and the unique identifier is produced and retained by the user. The user compares the tangible record with at least the first response and corrects any discrepancies therein by overwriting the most recent response stored.

According to another aspect, the present invention provides a method of voting which preserves the secrecy of the ballot while allowing a voter to verify the integrity of his or her vote in the official vote tabulation database. A unique identifier is generated and printed on an eligible voter's ballot and receipt. The ballot is compared with a predetermined standard to detect voter errors. An error report is printed if an error is detected. An official ballot and receipt, each including the unique identifier, is printed if no errors are detected. The receipt is signed and retained by the voter. The official ballot is collected and stored. The vote totals are transmitted to a central vote tabulation database where the voter can check to determine their vote was counted accurately.

In still another aspect of the invention, an information gathering system for allowing a user to verify the user's vote is provided. The system includes at least one computer, at least one printing device coupled to the computer, a software component executable by the at least one computer, and a communication network accessible to a qualified user. The communication network provides access to a tabulation database to allow the user to verify the user's voting choices and the voting choices of other voters. The software component is arranged to assign an identification number corresponding to an official ballot, where the identification number being assigned is based on the user's act of voting. The software component is further arranged to store the user's voting choices and the identification number in a tabulation database, and cause the computer to output on the printing device the official ballot, the official ballot including the identification number and a voting receipt, where the voting receipt includes the identification number. The identification number on the voting receipt is visible to allow the user to access the tabulation database to verify the integrity of the user's vote as printed on the official ballot after the official ballot has been tabulated.

In another aspect, a method for allowing a user to verify the user's vote is provided. The method includes requiring a user to provide to the computer a response to a ballot, assigning a unique identifier to the user's response to the ballot, storing the user's response to the ballot and the assigned unique identifier in a database, producing a first tangible record of the response for retention by the user, where the first tangible record includes the assigned unique identifier, producing a second tangible record of the response, where the second tangible record includes the user's response to the ballot and the assigned unique identifier, using the unique identifier to allow the user to confirm that the collected second tangible record represents the vote intended to be cast by the user by allowing the user to access the database using the unique identifier, and providing the user with access to a communication network such that the user is able to verify the user's voting choices and voting choices of other voters.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of a typical election workstation configured according to an embodiment of the invention;

FIG. 2 is a flow chart outlining the steps required to produce a custom ballot according to an embodiment of the invention;

FIG. 2A is a flow chart outlining the steps required to produce a custom ballot according to an embodiment of the invention;

FIG. 3 is a flow chart showing a voting process according to an embodiment of the invention;

FIG. 4 is a flow chart demonstrating voter error checking according to an embodiment of the invention;

FIG. 5 is a flow chart of a vote verification process according to an embodiment of the invention;

FIG. 6 is a flow chart showing a vote recount according to an embodiment of the invention;

FIG. 7 is a block diagram of a reporting arrangement according to an embodiment of the invention;

FIG. 8 is an example of an input ballot arranged according to an embodiment of the present invention;

FIG. 9 is an example of a voter receipt arranged according to an embodiment of the invention;

FIG. 10 is an example of an official ballot printed in accordance with an embodiment of the present invention;

FIG. 11 is an example of an error report generated according to an embodiment of the present invention;

FIG. 12 is an example of an official vote tabulation summary that a voter may access; and

FIG. 13 is an example of a detailed official vote tabulation that a voter may access.

### DETAILED DESCRIPTION OF THE INVENTION

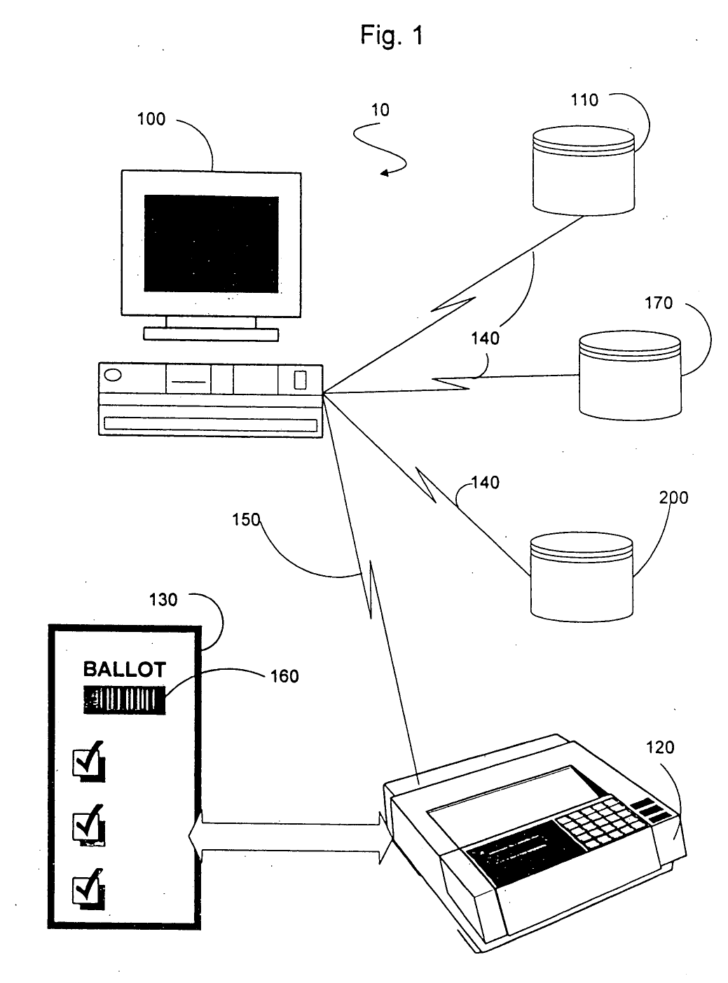

Referring to FIG. 1, a election workstation, shown generally as 10, includes a computer 100 connected to a ballot form database 110, a printer/scanner 120, a voter registration database 170, and a local recorded vote database 200. Printer/scanner 120 may be locally connected to computer 100 or networked by connecting to a communication network 150 such as a local area network (LAN) or the Internet. Several election workstations 10 can be used at a single polling location depending on the size of the precinct. Ballot form database 110 and voter registration database 170 can physically reside on a storage device such as a hard-drive or CD-ROM in each computer 100 or ballot form database 100 and/or voter registration database 170 may be connected across a network. It is also possible to access ballot form database 110 or voter registration database 170 by connecting to a communication network 140 such as the LAN or Internet. Although ballot form database 110 and voter registration database 170 are shown as separate components, it is understood that the ballot form database 110 can physically reside in computer 100 or even at a remote location connected through the communication network 140. It should also be evident that a separate scanner and separate printer can be used in place of integrated printer/scanner 120.

Computer 100 is provided with a software component that is typically written in a machine-readable language such as C++ or Visual Basic or any acceptable programming language. The software component performs any of the functions described herein including enabling computer 100 to receive and output information.

Printer/scanner 120 is used to produce a paper ballot 130. Ballot form database 110 includes ballot information for all national, state and local elections, allowable language options, and an audio version or other accessibility enhanced options for the disabled. Ballot form database 110 and voter registration database 170 are present in all polling places within the election jurisdiction thus allowing the eligible voter to cast their ballot at any polling place within the election jurisdiction regardless of where the voter is actually registered to vote. In order to ensure that a voter does not vote more than once, any voters who choose to vote at an election polling place other than their assigned polling place will have their vote placed on hold until compared with the voting data from the rest of the election jurisdiction. If the voter has not registered another vote, the vote becomes official and is entered into the tally. If the voter is shown to have voted at more than one location, the votes are not entered and the name and address may be given to the authorities for further investigation. Because paper ballots are printed as needed, the cost of preprinting the ballots is eliminated and waste is reduced. Only ballots actually needed are printed.

Ballot 130 includes a computer generated unique identifier or identification number 160 that is used for security and identification. Number 160 may be a random character string or other securely generated character string as is known in the art. Ideally, number 160 should be large enough to reduce the chance of two voters being assigned the same number 160 to almost zero. Additionally, number 160 may be encoded so that number 160 is not readily interpretable, further increasing security. Bar coding or any other suitable method may be used.

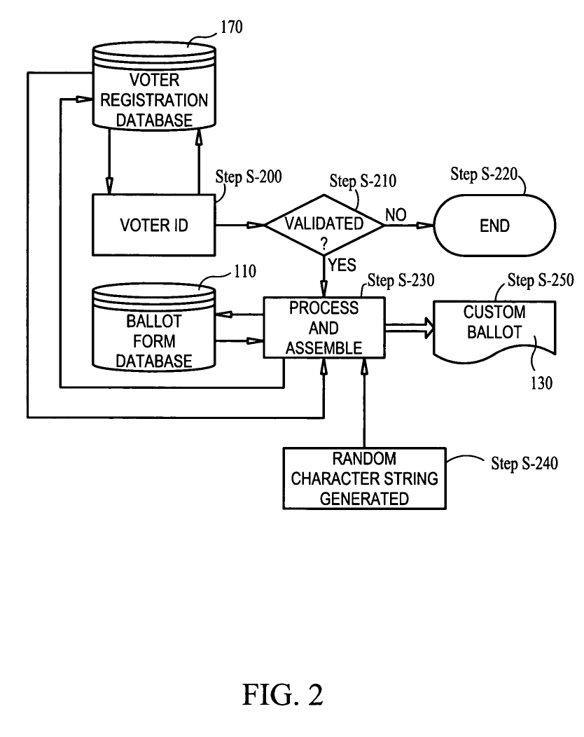

Ballot production is explained with reference to FIG. 2. Initially, a voter presents an acceptable form of identification (step S-200) to initiate the voting process by referring to voter registration database 170. Examples of acceptable identification include a driver's license, state issued identification or voter registration card. The voter is validated in step S-210 if the identification presented matches the voter's information stored in voter registration database 170 and the voter has not previously recorded a vote in the present election. It is contemplated that validation step S-210 is performed by a human election worker; however, it is known to electronically verify a person's identity and any acceptable form of validation may be used to perform step S-210. Biometric devices, for example, are known in the art and could be adapted to perform validation step S-210.

In some states, it is possible to register the day of the election, even if the voter has never registered before. The process involved, when a first time voter registers the day of the election, is shown by referring to FIG. 2A. The steps are similar to the steps detailed above except that if the voter is not validated and is a first time voter in a state allowing same day registration (step S-211), the first time voters may be given the opportunity to register for the first time (step S-212) according to one embodiment of the invention. If the first time voter does not wish to register, the process ends (step S-220). First time voters who want to register may be registered (step S-213) by updating voter registration database 170. The registered first time voter is validated in step S-210 and the process continues in a manner identical for validated, already registered voters.

If the voter cannot be validated or has previously voted in the present election, the voting process ends (step S-220). The voter may be referred to an election supervisor. It is possible for the election supervisor to “conditionally validate” and place the vote on hold in the same manner as when a voter chooses to vote at a polling place other than the one to which he or she is assigned.

If the voter is validated, the relevant information (i.e., name and address) is processed within computer 100 (step S-230) by referring to ballot form database 110 and voter registration database 170. Voter registration database 170 contains the name, address, registration number, signature, identification information, and a record of any previous vote cast in the present election for all registered voters in the election jurisdiction. Voter registration database 170 is checked to make sure the voter is registered, confirm the voter's identification via signature verification and/or identification number and prohibit the voter from voting more than once in the same election. Ballot form database 110 may be provided by a state or local election board or may be independently compiled by a third party. Ballot form database 110 includes a complete listing of all approved legal ballots within a voting jurisdiction. The comprehensive voting jurisdiction-wide ballot form database 110 and voter registration database 170 allows voters the option to vote at any polling location within the voting jurisdiction rather than only at the polling location assigned to them.

In step S-230, ballot 130 is processed and assembled by referring to ballot form database 110, voter registration database 170 and generating a unique identification number 160 (step S-240). Any suitable method for generating a unique identifier 160 may be utilized. Unique identifier 160 is printed on ballot 130, thereby producing a custom ballot (step S-250) that includes all the information required on a legal ballot based on the voter's identity, address and allowable language preference as validated in step S-210 along with unique identification number 160. Although the invention is described as producing paper custom ballot 130, it is readily apparent to one skilled in the art that custom ballot 130 can be rendered on any suitable medium as long as ballot 130 functions as input to the voting system. For example, ballot 130 can be electronically displayed on a touch screen computer monitor allowing a voter to touch the screen thereby indicating his or her vote. It is possible for a visually impaired voter to use the present invention by using an electronic transmission device such as a telephone, computer, personal digital assistant or cellular phone to enter the voter's identification information as well as the vote. The system 10 accepts speech entry of information and voting choices and provides audio feedback to the visually impaired voter. Such speech recognition systems are known in the art and any suitable audio system that allows the present invention to be practiced without a printed ballot is acceptable.

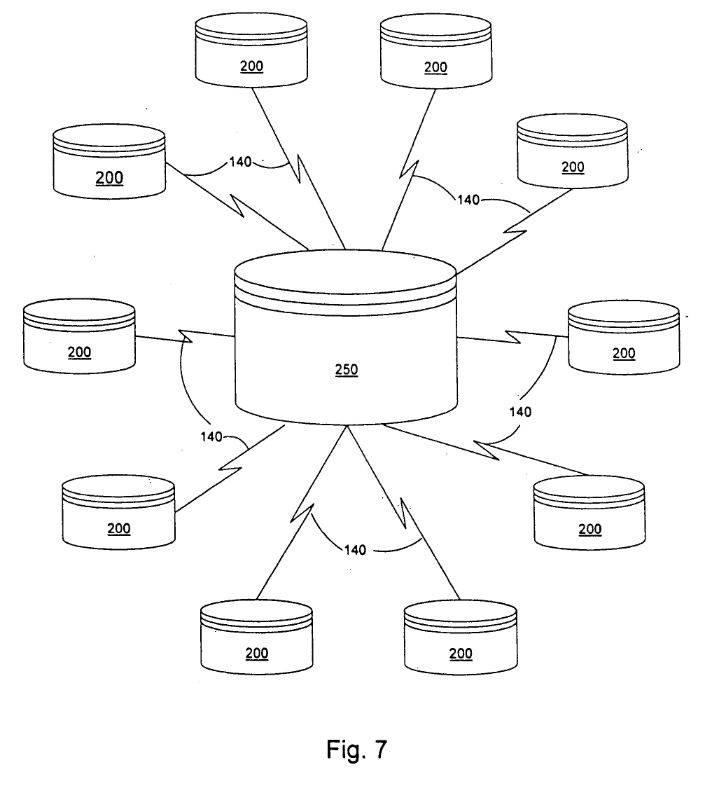

The voting process of the present invention is explained with reference to FIGS. 1,3, 4, 7 and 8. The voter fills out his or her ballot 130 by blackening or checking the box corresponding to the selection (or pressing the screen or speaking the selection as discussed above.) The completed ballot 130 becomes an input ballot 135, an example of which is shown in FIG. 8. Input ballot 135 is scanned (step S-300) using scanner/printer 120. An error detection routine (step S-310) is used to detect any errors in input ballot 135. Examples of errors include overvotes and unintentional undervotes, and will be described in more detail below. If no errors are detected, the vote is tallied by entering the error free vote (step S-320) into local recorded vote database 200.

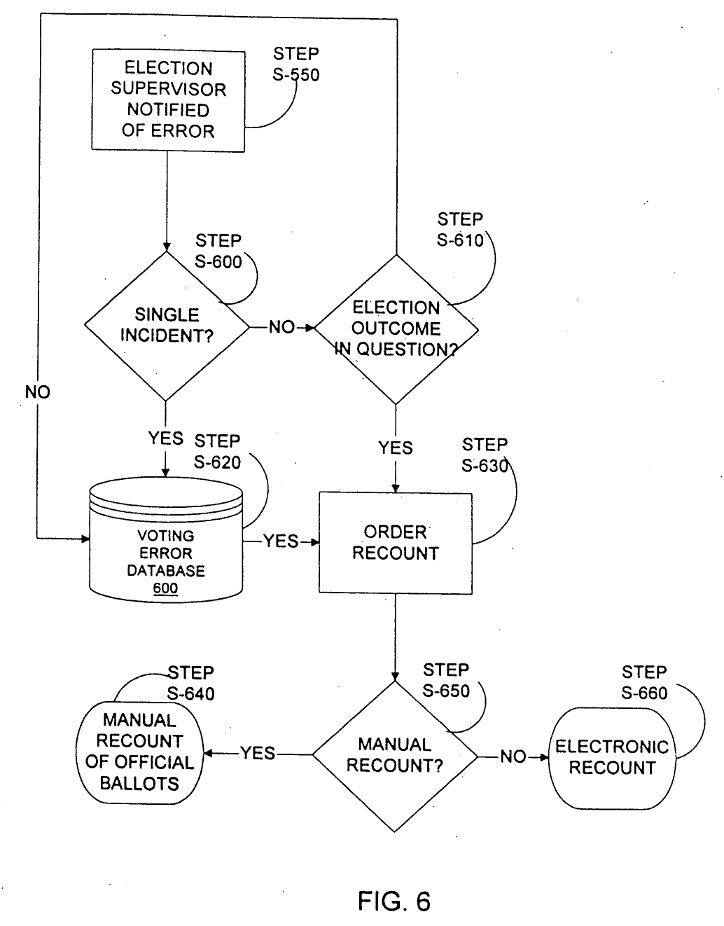

As shown in FIG. 7, local recorded vote database 200 may be linked to a central recorded vote database 250. Local recorded vote database 200 is used by the election workstation 10 to store and tabulate all error free ballots. In order for the results of the election to be determined, all individual local recorded vote databases 200 must be counted. Central recorded vote database 250 is used to tabulate the results from local recorded vote databases 200. A communication network such as a secure intranet may be used to transmit the data from local recorded vote databases 200 to central recorded vote database 250.

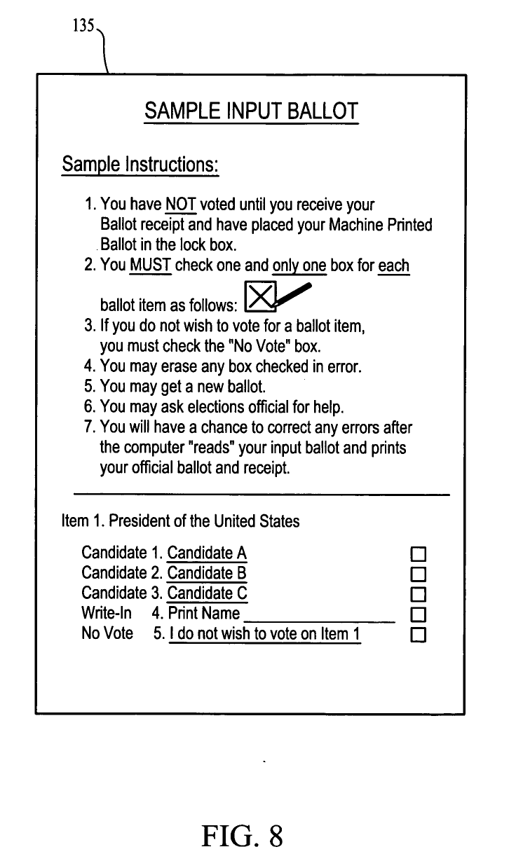

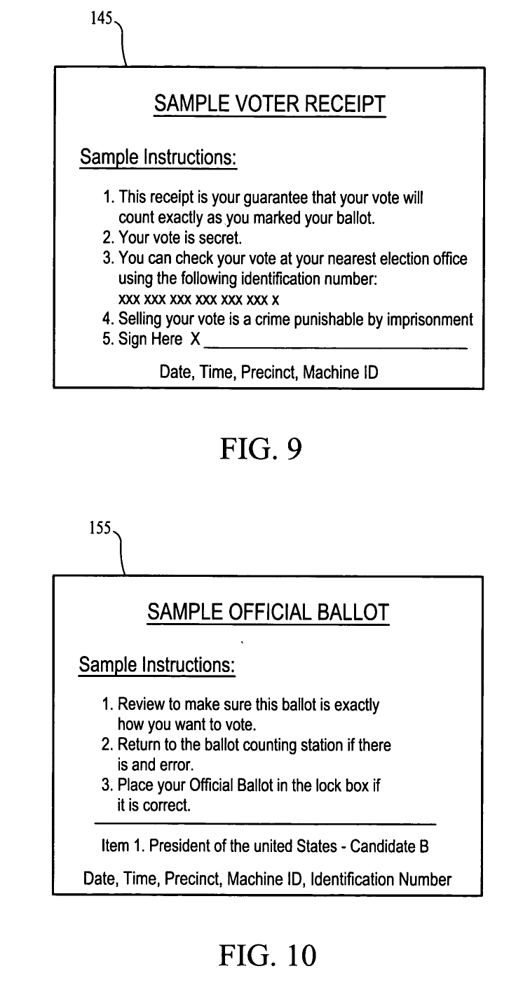

Once the vote has been entered into local recorded vote database 200 (step S-320), scanner/printer 120 is used to print an official ballot 155 and a voter receipt 145. An example of voter receipt 145 and official ballot 155 are shown in FIGS. 9 and 10 respectively. The voter is given their official ballot 155 and voter receipt 145 and the voter reviews official ballot 155 (step S-335). If the voter determines there is a discrepancy between their intent and official ballot 155, they may change input ballot 135 and re-enter it into local recorded vote database 200 (step 336). Local recorded vote database 200 is accessed using unique identification number 160 and, upon verification of unique identification number 160, the original vote is erased and the data from re-entered input ballot 135 is recorded. Official ballot 155 is collected by election officials (step S-340) and secured. Official ballot 155 is used when the results of an election are in dispute. Official ballot 155 provides a very accurate paper record which indicates clear voter intent without the possibility of voter error. The voter signs and retains receipt 145 (step S-345). Both official ballot 155 and voter receipt 145 also have unique identification number 160, date, time, precinct and machine identification information printed thereon.

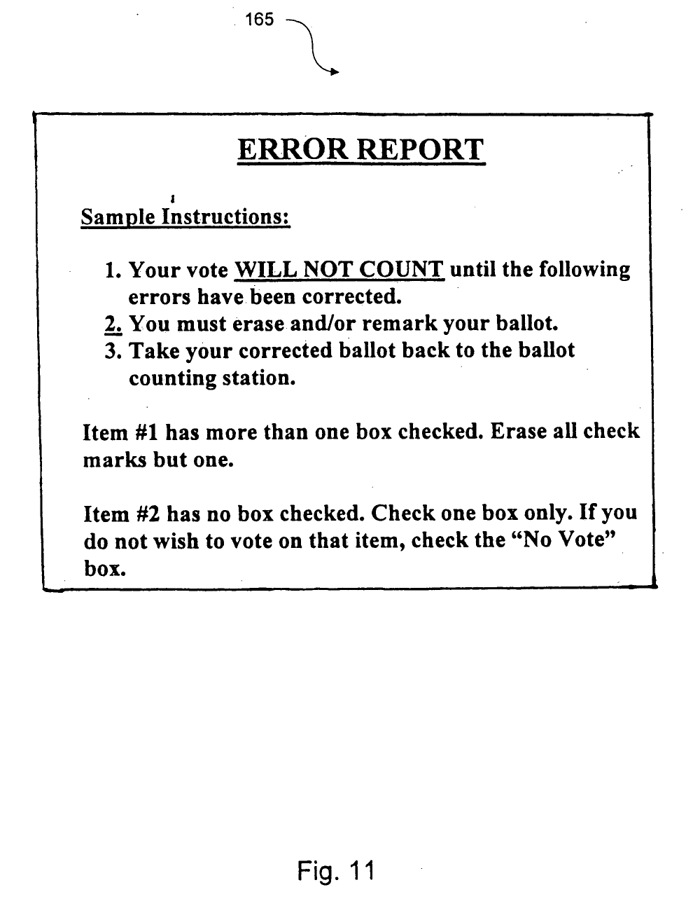

If an error is detected (step S-310), it is necessary to determine what kind of error exists (step S-350). As discussed above, voter error includes overvotes and unintentional undervotes. Non-voter error is classified as a technological breakdown such as when scanner/printer 120 is unable to accurately read input ballot 135 and also includes software errors, power failures and other like problems. An error report 165 is generated (step S-325) and indicates the kind of errors detected. An example of error report 165 is shown in FIG. 11. Voter error is discussed first.

As noted above, voter error can be broken down into two basic categories. The first is known as an overvote. An overvote occurs when a voter selects more than one choice for a single ballot item. Examples include selecting two candidates for the Office of President, or choosing both yes and no on a bond issue. Overvotes are easily detected by the system 10.

Likewise, undervotes are easily detected and occur when no vote appears for a ballot item. Examples of undervotes include no choice indicated for president or a completely blank ballot. Although all ballot items left blank are potentially undervotes, voters can leave a particular item blank and the voter's intent to leave an item blank must be distinguished from voter error or neglect. Input ballot 135 has a “no vote” box that a voter uses to indicate that he or she does not intend to make a choice for a particular ballot item. An example of input ballot 135 is shown in FIG. 8. An input ballot containing a checked “no vote” box will not result in an error.

When either an unintentional undervote or overvote error is detected (step S-350), error report 165 is generated (step S-325). The voter is given error report 165 and original input ballot 135. The voter then corrects input ballot 135 (step S-360) by erasing overvotes or stray marks (step S-440), and/or by selecting a choice or marking “no vote” on undervotes (step S-430). It is possible to issue the voter a new customized ballot 130 in which a new unique identification number 160 is generated by first instructing system 10 to erase all votes recorded in local recorded vote database 200 for the original input ballot 135 using the unique identifier that was generated and printed on the original ballot. The corrected (or new) ballot 135 is scanned (step S-300) and the process repeats to ensure all errors are corrected and no new errors are introduced.

If it appears that input ballot 135 is marked correctly, yet system 10 rejects input ballot 135 as having an error, hardware such as a scanner/printer 120 may be replaced (step S-370). Once the hardware has been replaced, input ballot 135 is rescanned (step S-300) and the process repeats. If the error persists, the entire system 10 may be replaced.

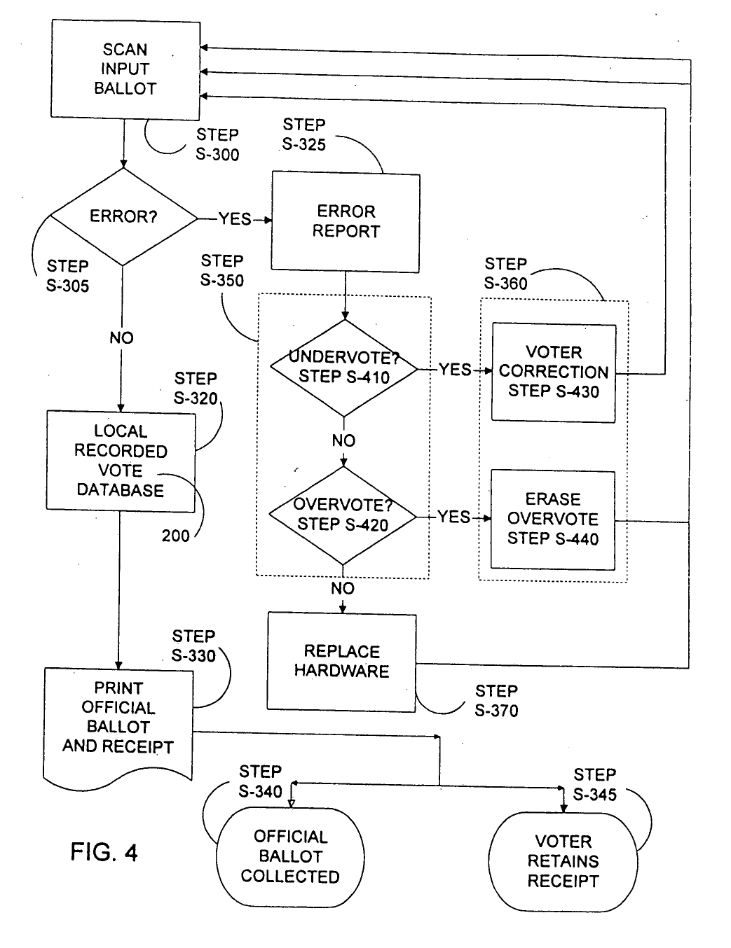

The process of allowing the voter to audit the accuracy of their vote in the election tabulation database while preserving the voter's anonymity is explained with reference to FIGS. 5 and 7. The voter visits an office of the election official and presents his or her voter ID and the signed voter receipt 145. The election official matches the signature on file with the signature on receipt 145 (step S-515). If there is a match, the voter is given private access to the central recorded vote database 250 using a secure intranet connection. By entering his or her unique identification number 160, the voter is presented with a screen image of the official ballot 155 associated with unique identification number 160 as is known in the art (step S-530). The voter then verifies that his or her vote, as recorded on the official ballot 155 matches the information displayed on the screen (step S-540). If there is a discrepancy, the proper election official is notified (step S-550). If no discrepancy is detected, the voter confirms the accuracy of his or her vote (step S-560). This arrangement engenders a great deal of voter confidence in the integrity of system 10.

If the voter is unable to be verified (step S-520), the voter may be asked to try again (step S-570) and re-enter unique identification number 160 (step S-510), or else the process ends (step S-580). Of course, the voter may be redirected to help screens or disconnected from the website after a predetermined number of unsuccessful log-in attempts are exceeded as known in the art to minimize the possibility of compromising the security of system 10. If no official ballot image is displayed, the proper election official is notified (step S-550).

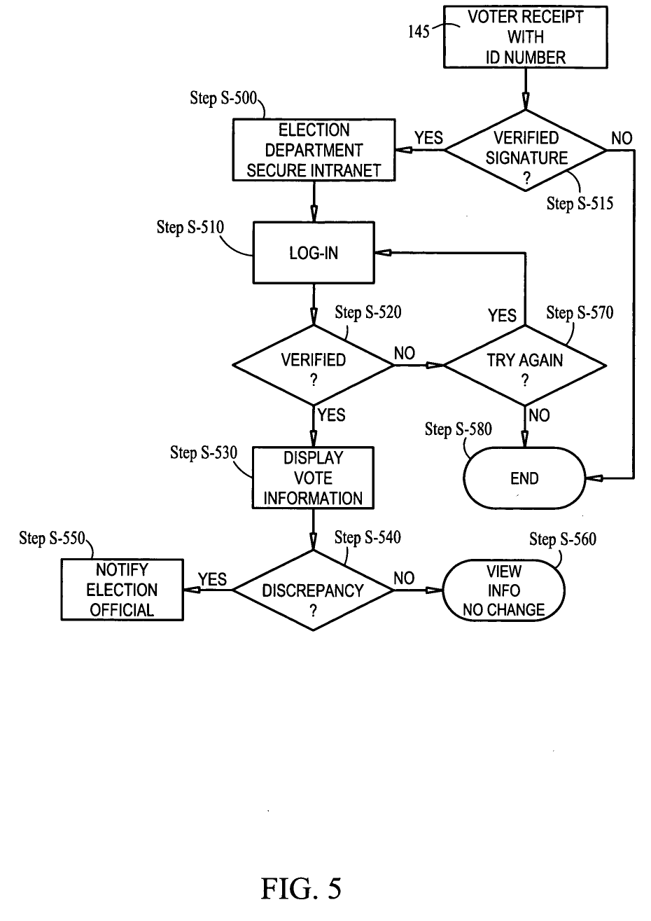

FIG. 6 illustrates how a discrepancy can be dealt with once the election supervisor is notified (step S-550). If the discrepancy is a single incident (step S-600) with no clear discernable pattern suggestive of a more serious problem, the single incident is sent to a voting error database 600 in order to monitor and detect any potential problems (step S-620). Should the database reveal any systemic errors or other patterns of error which could affect the outcome of an election, the election supervisor can order a recount (step S-630). If a recount is ordered, it may be an electronic recount (step S-660) of the data from one or more local recorded vote database(s) 200. If the discrepancy is not resolved, or at the discretion of the election supervisor, a manual recount of the collected and secured official ballots 155 may be ordered (step S-640). This recount may be performed electronically or by actual human inspection and provides an independent, highly reliable and clear record of voter intent.

Voter error database 600 can include a “trigger” which orders a recount if the number of reported discrepancies exceed a certain level which could affect the outcome of the election (step S-630). If the discrepancies are widespread (step S-600), the outcome of an election may be impacted and a recount may immediately be ordered (step S-630). The recount proceeds as discussed above. If the outcome of the election is not in question, the multiple discrepancies are stored in voting error database 600 as discussed above.

As discussed above, each polling location either has or is connected to local recorded vote database 200. Local recorded vote database 200 stores all the error free votes. The information contained in each local recorded vote database 200 and voter registration database 170 needs to be centrally compiled to facilitate a final tally as well as to clear those votes which are on hold and considered provisional from voters choosing to cast their ballots at a location other than the one where they are registered. The central compilation also serves to detect multiple votes from a single registered voter using voter registration database 170.

Central recorded vote database 250 is used to compile and process the data from local recorded vote databases 200. Local recorded vote databases 200 upload the data using a communication network 140 such as a secure intranet connection to communicate with central recorded vote database 250. Any acceptable means of transmitting the data from local recorded vote database 200 to central recorded vote database 250 may be used including physically transporting local database 200 or copies of the data to central database 250.

Although the invention has been described in terms of voting and elections, the invention is perfectly suited for use as a polling system unrelated to voting such as a survey or other information gathering application. Those skilled in the art would readily recognize that little, if any, modification would be needed to gather survey information using the present invention.

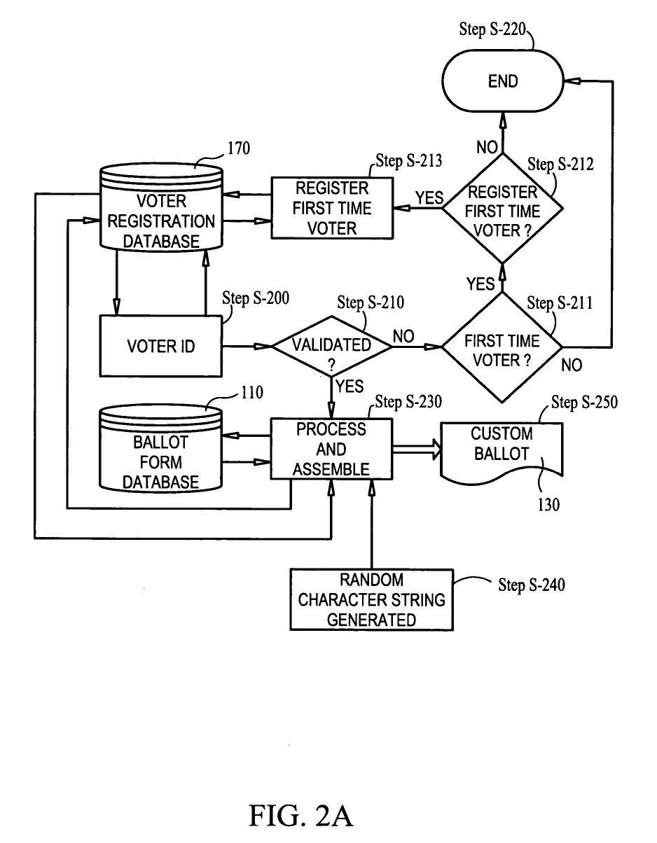

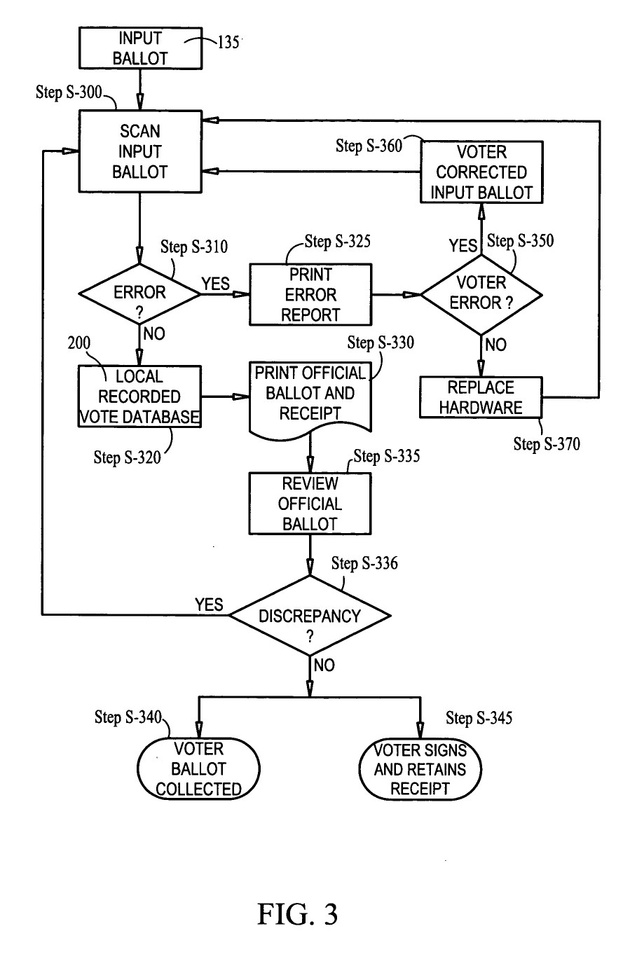

Another embodiment of the present invention, referring again to FIGS. 1-5, utilizes a home, office or publicly available computer and a communication network such as the Internet to access voting system 10 from a location other than an official voting station. The voter accesses a voting website and logs in (step S-510) as discussed above. Once validated and confirmed as a registered voter in voter registration database 170 who has not previously voted in the present election (step S-200), the voter is presented with a custom ballot (step S-250) on his or her computer screen. The voter selects his or her choices on electronic ballot 130 and the votes are directly checked for errors (step S-310). Scanning ballot 130 in step S-300 is not needed. The rest of the process proceeds as discussed above except that because the voter is not physically at a voting station, the voter must print and deliver official ballot 155 with unique identifier 160 to the proper election officials. The voter may deliver official ballot 155 by mail, hand delivery or any other acceptable delivery method that includes proper identification as a registered voter such as by signature verification. The voter also prints, signs and retains voter receipt 145 with the unique identifier 160 for use in verifying his or her vote as described above.

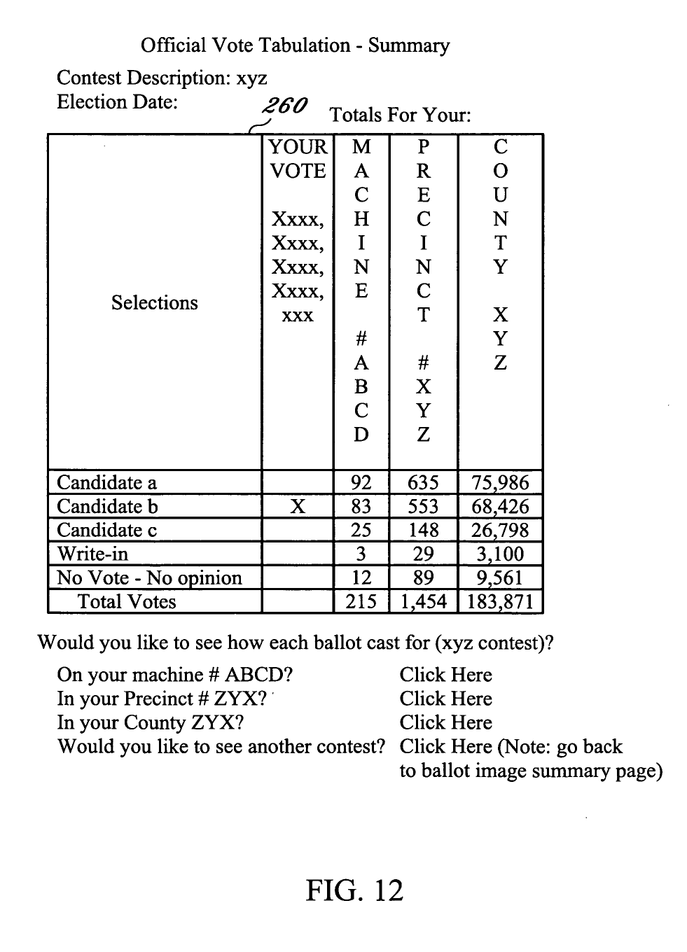

Referring now to FIG. 12, an exemplary official vote tabulation screen, in summary form 260, can be seen. The summary tabulation screen 260 may be presented to the voter when he or she logs onto the communication network to verify their vote. In one embodiment, the communication network is a secure intranet that a voter accesses in order to receive voter tabulation information. The voter would arrive at a tabulation access center and present a copy of their voter ID and signed receipt 145. An election official would verify the voter's signature as being the same as on receipt 145 by matching the signature in the voter registration file. Only after the voter's signature on receipt 145 has been authenticated is the voter allowed to access the vote tabulation database.

The voter is given private access to the recorded vote database 250 and enters their identification number 160. The screen presented in FIG. 10 is an exemplary image of the voter's official ballot 155. The voter can then select any contest (i.e., election) and the screen presented in FIG. 12 is an exemplary image of all the vote totals in the election jurisdiction. The voter can view all the ballots cast but cannot see any of the identification numbers 160 except the voter's own. In the example shown in FIG. 12, the voter can view and verify that their vote for candidate b was received and counted. In addition, the voter is presented with the ability to determine how many votes their candidate (and other candidates) received by subcategory. The subcategories can be any category, for example, total votes by machine, by precinct or by the entire election jurisdiction.

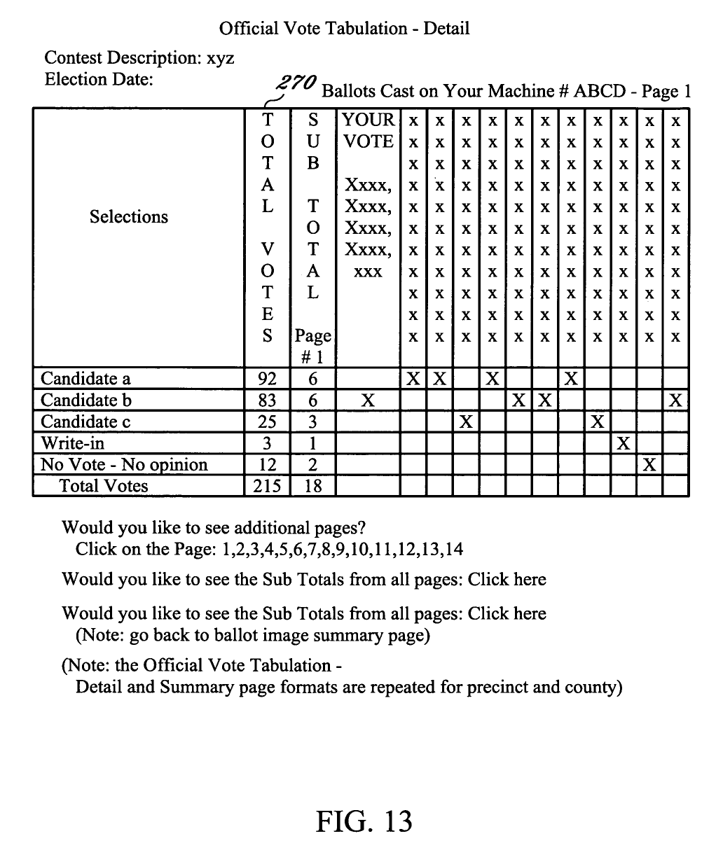

In FIG. 13, another exemplary vote tabulation screen 270 is shown. This screen provides the voter with detailed voting information of not only their own vote, but also the votes of others. The names of all voters who cast a ballot in the election are accessible but cannot be linked to a ballot. The voter may, for example, add the votes on his or her machine to check for accuracy. Media representatives, candidates, party official, campaign workers, and political scientists who voted and retained their receipt would be able to audit the entire recorded vote database 250, by logging onto database 250 in the secure manner described above, and viewing the accuracy of the tabulated results.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. An information gathering system for allowing a user to verify the user's voting choices, the system comprising:
at least one computer;
at least one printing device coupled to the at least one computer;
a software component executable by the at least one computer, the software component being arranged to:
assign an identification number corresponding to an official ballot, the identification number being assigned based on the user's act of voting;
store the user's voting choices and the identification number in a tabulation database; and
cause the computer to output on the printing device:
the official ballot, the official ballot including the identification number; and
a voting receipt, the voting receipt including the identification number, wherein the identification number on the voting receipt is visible to allow the user to access the tabulation database to verify the integrity of the user's vote as printed on the official ballot after the official ballot has been tabulated; and
a communication network accessible to a qualified user, the communication network providing access to the tabulation database to allow the user to verify the user's voting choices and voting choices of other voters.

2. The system of claim 1, wherein the unique identifier is printed on the official ballot and voting receipt to allow for confidential verification of the integrity of the user's voting choices without giving the user a physical copy of the user's vote.

3. The system of claim 1, wherein the tabulation database corresponds to an official vote tabulation database.

4. The system of claim 1, wherein a bar code corresponding to the unique identifier is printed on at least one of the voting receipt and the official ballot.

5. The system of claim 1, wherein the identification number is a large randomly generated character string.

6. The system of claim 1, wherein upon access to the tabulation database via the communication network, the user is able to view the names of other voters who cast a ballot and each anonymous official ballot.

7. The system of claim 1, wherein upon access to the tabulation database via the communication network, the user is able to select a subcategory and view the number of total votes for each candidate by the subcategory.

8. The system of claim 7, wherein the subcategory is one of at least a voting machine, a voting location, and an election jurisdiction.

9. The system of claim 1, where the communication network is a secure intranet accessible to the user only after the user's identity has been verified.

10. The system of claim 8, wherein the user's identity is verified by authentication of the user's identification number and the user's signature.

11. A method for allowing a user to verify the user's vote, the method comprising:
requiring a user to provide to the computer a response to a ballot;
assigning an identification number to the user's response to the ballot;
storing the user's response to the ballot and the assigned identification number in a database;
producing a first tangible record of the response for retention by the user, the first tangible record including the assigned identification number;
producing a second tangible record of the response, the second tangible record including the user's response to the ballot and the assigned identification number;
using the identification number to allow the user to confirm that the collected second tangible record represents the vote intended to be cast by the user by allowing the user to access the database using the identification number; and
providing the user with access to a communication network such that the user is able to verify the user's voting choices and voting choices of other voters.

12. The method of claim 11, further comprising confirming that the user's vote was printed on the second tangible record as intended by the user, wherein the confirmation occurs after the second tangible record is collected.

13. The method of claim 11, wherein requiring the user to provide to the computer a response to the ballot comprises:
inputting the response into the computer;
checking the response by comparing the response to a selected standard;
rejecting the response if the response does not meet the requirements of the selected standard; and
requiring the user to correct the rejected response.

14. The method of claim 11, wherein confirming that the second tangible record represents the vote intended to be cast by the user further includes comparing the user's response to the ballot stored in the database with the user's response to the ballot printed on the second tangible record.

15. The method of claim 11, wherein the identification number is printed on the official ballot and voting receipt to allow for confidential verification of the integrity of the user's response without giving the user a physical copy of the user's vote.

16. The method of claim 11, wherein the database corresponds to an official vote tabulation database.

17. The method of claim 11, wherein a bar code corresponding to the identification number is printed on at least one of the voting stub and the official ballot.

18. The method of claim 11, wherein the identification number is a randomly generated large character string.

19. The method of claim 11, wherein upon access to the communication network, the user is able to view the names of other voters who cast a ballot and each anonymous ballot as counted in the official vote tabulation database.

20. The method of claim 11, wherein providing the user with access to the database such that the user is able to verify the user's voting choices and voting choices of others includes allowing the user to select a subcategory in order to view the number of total votes for each candidate by the subcategory.

21. The method of claim 20, wherein the subcategory is one of at least a voting machine, a voting location, and an election jurisdiction.

22. The method of claim 11, where the communication network is a secure intranet accessible to the user only after the user's identity has been authenticated.

23. The method of claim 22, wherein the user's identity is authenticated by verification of the user's identification number and the user's signature.
